(19) United States
(12) Patent Application Publication
(10) Pub. No.: US 2026/0153671 A1
(43) Pub. Date: Jun. 4, 2026

(54) ANTI-RESONANT HOLLOW CORE OPTICAL FIBER WITH RECESSED CLADDING TUBE

(71) Applicant: CORNING INCORPORATED, CORNING, NY (US)

(72) Inventors: Paulo Clovis Dainese, JR., Painted Post, NY (US); Ming-Jun Li, Horseheads, NY (US); Dan Trung Nguyen, Painted Post, NY (US); Ilia Andreyevich Nikulin, Leland, NC (US)

(21) Appl. No.: 19/275,213

(22) Filed: Jul. 21, 2025

Related U.S. Application Data
(60) Provisional application No. 63/679,009, filed on Aug. 2, 2024.

(51) Int. Cl. G02B 6/02

(52) U.S. Cl. CPC G02B 6/02357; G02B 6/02328

(57) ABSTRACT

An anti-resonant hollow core optical fiber including: (A) a fiber longitudinal axis extending from a first end to a second end; (B) a cladding tube through which the fiber longitudinal axis extends, the cladding tube (1) extending longitudinally from the first end to the second end, (2) disposed azimuthally around the fiber longitudinal axis, and (3) including (a) a cladding outer surface at a cladding outer radius from the fiber longitudinal axis and (b) a cladding inner surface comprising at least one recess; and (C) at least one anti-resonant element in contact with the cladding inner surface, the at least one anti-resonant element extending longitudinally from the first end to the second end. The cladding inner surface is disposed at a cladding inner radius that has azimuthal variability (e.g., is not constant entirely) around the fiber longitudinal axis to define the at least one recess.

This application claims the benefit of priority to U.S. Provisional Patent Application Ser. No. 63/679,009 filed on Aug. 2, 2024, the content of which is relied upon and incorporated herein by reference in its entirety.

### TECHNICAL FIELD

The present disclosure pertains to an anti-resonant hollow core optical fiber, and more particularly, to an anti-resonant hollow core optical fiber with a cladding tube with at least one recess therein.

### BACKGROUND

Optical fibers are utilized to transmit data. More particularly, a transmitter converts information into pulses of electromagnetic radiation and transmits the pulses into the optical fiber. The electromagnetic radiation transmits along the optical fiber to a receiver. The receiver re-converts the pulses of electromagnetic radiation back into information.

Optical fiber often includes a solid core through which the electromagnetic radiation moves and a cladding surrounding the solid core to maintain the electromagnetic radiation within the solid core. The cladding and the solid core exhibit different indices of refraction, and the difference causes the electromagnetic radiation to stay generally within the solid core during transmission due to total internal reflection. The solid core of the optical fiber is often formed of silica-based glass.

Transmission performance of optical fibers with a solid core can suffer from confinement loss and losses due to scattering, absorption, and bending. Imperfection in the material of the solid core can cause scattering and absorption of the electromagnetic radiation pulses that the optical fiber is transmitting. Further losses of the intensity of the electromagnetic radiation from the core into the cladding occur due to external perturbations, such as bending and stresses when optical fibers are packed and deployed in cables. Confinement losses result from leaky modes in the optical fiber. Leaky modes have evanescent fields of optical signal intensity that extend beyond the core into the cladding. Losses due to scattering, absorption, and lack of confinement reduce the power of the electromagnetic radiation pulses. Reduced power limits the ability of the receiver to convert the pulses back into information, which limits the reach of the optical fiber.

In an effort to improve the performance of optical fibers, hollow core optical fibers are under development. Hollow core optical fibers mitigate attenuation of optical signals and provide further advantages such as low non-linearity, low dispersion, and low latency. Hollow core optical fibers, as the name suggests, do not include a core of solid material. Rather, the core is a gas, such as air. Due to the absence of a solid core, it is thought that the electromagnetic radiation could transmit without as much scattering and absorption loss.

There is still the issue of confinement of the electromagnetic radiation within the core. A category of hollow core optical fibers relies upon anti-resonance between the core and the cladding to confine the electromagnetic radiation within the core and to prevent leakage of modes into the cladding. Those optical fibers are sometimes referred to as anti-resonant hollow core optical fibers, or AR-HCFs for short. With AR-HCFs, a central hollow core is surrounded by anti-resonant cladding elements contained in a cladding tube. The anti-resonant cladding elements can be made of relatively thin glass to realize an anti-resonant effect. Anti-resonance occurs when electromagnetic radiation within any of the anti-resonant cladding elements destructively interferes with itself, resulting in minimum transmission of optical power through the glass of the anti-resonant element. The greater the anti-resonant effect of the cladding elements, the greater the confinement of electromagnetic radiation within the core, and thus the lower the confinement loss.

Engineering and design of anti-resonant cladding elements to achieve better confinement loss across desirable wavelength ranges is an evolving field of endeavor. In addition, there is a practical problem in that AR-HCFs are difficult to manufacture at large scale. The anti-resonant cladding elements must satisfy exacting structural requirements to perform efficiently and are highly sensitive to dimensional fluctuations expected from manufacturing variability. For example, if anti-resonant cladding elements designed not to contact each other but do as a result of manufacturing imprecision, the anti-resonant hollow core optical fiber exhibits peaks in confinement loss as a function of wavelength. Further, inaccuracies in the azimuthal position of the anti-resonant cladding elements relative to each other impacts the confinement loss. Furthermore, it is difficult to manufacture the anti-resonant hollow core optical fiber where the anti-resonant cladding elements do not make contact and/or where the anti-resonant cladding elements are drawn in their as-designed azimuthal position. All AR-HCFs to date have included a cladding tube with a perfectly cylindrical inner surface, which makes it difficult to control and maintain placement of the anti-resonant cladding elements during fiber draw.

### SUMMARY

The present disclosure addresses that problem with an anti-resonant hollow core optical fiber with a cladding tube having an inner surface with at least one recess therein and at least one anti-resonant element within the cladding tube associated with the at least one recess. The incorporation of the at least one recess affords more space to place the at least one anti-resonant element, which may permit reduction of the diameter of the anti-resonant hollow core optical fiber. With the additional space, there is more flexibility to place the at least one anti-resonant element so confinement loss can be reduced. Notably, the confinement loss as a function of wavelength that the anti-resonant hollow core optical fiber of the present disclosure exhibits lacks steep peaks, which anti-resonant hollow core optical fibers of other constructions have exhibited. Placement of an anti-resonant element within a recess may also stabilize and secure the position of the anti-resonant element during fiber draw to improve the consistency of fiber manufacturing. Moreover, the inclusion of the at least one recess

According to a first aspect of the present disclosure, an anti-resonant hollow core optical fiber comprises: (A) a fiber longitudinal axis extending from a first end to a second end; (B) a cladding tube through which the fiber longitudinal axis extends, the cladding tube (1) extending longitudinally from the first end to the second end, (2) disposed azimuthally around the fiber longitudinal axis, and (3) comprising (a) a cladding outer surface at a cladding outer radius from the fiber longitudinal axis and (b) a cladding inner surface comprising at least one recess; and (C) at least one anti-resonant element in contact with the cladding inner surface, the at least one anti-resonant element extending longitudinally from the first end to the second end.

According to a second aspect of the present disclosure, the anti-resonant hollow core optical fiber of the first aspect is presented, wherein the cladding inner surface is disposed at a cladding inner radius that has azimuthal variability around the fiber longitudinal axis to define the at least one recess.

According to a third aspect of the present disclosure, the anti-resonant hollow core optical fiber of the second aspect is presented, wherein the azimuthal variability of the cladding inner radius is periodic to define a plurality of recesses, the plurality comprising the at least one recess.

According to a fourth aspect of the present disclosure, the anti-resonant hollow core optical fiber of any one of the second through third aspects is presented, wherein (i) the cladding tube further comprises a cladding thickness between the cladding outer radius and the cladding inner radius, and (ii) the cladding thickness has azimuthal variability around the fiber longitudinal axis.

According to a fifth aspect of the present disclosure, the anti-resonant hollow core optical fiber of any one of the first through fourth aspects is presented, wherein the at least one anti-resonant element is a capillary tube.

According to a sixth aspect of the present disclosure, the anti-resonant hollow core optical fiber of any one of the first through fifth aspects is presented, wherein the at least one anti-resonant element has an arcuate, elliptical, or circular cross-sectional segment.

According to a seventh aspect of the present disclosure, the anti-resonant hollow core optical fiber of any one of the first through sixth aspects is presented, wherein the at least one anti-resonant element contacts the cladding inner surface at the at least one recess.

According to an eighth aspect of the present disclosure, the anti-resonant hollow core optical fiber of any one of the first through seventh aspects is presented, wherein the at least one anti-resonant element is at least partially situated within the at least one recess.

According to a ninth aspect of the present disclosure, the anti-resonant hollow core optical fiber of any one of the first through eighth aspects is presented, wherein the cladding inner surface further comprises a plurality of recesses into the cladding tube, the plurality comprising the at least one recess.

According to a tenth aspect of the present disclosure, the anti-resonant hollow core optical fiber of the ninth aspect is presented, wherein the cladding inner surface includes a total of from 3 to 12 recesses.

According to an eleventh aspect of the present disclosure, the anti-resonant hollow core optical fiber of the tenth aspect is presented, wherein the cladding inner surface includes a total of 5 or 6 recesses.

According to a twelfth aspect of the present disclosure, the anti-resonant hollow core optical fiber of any one of the ninth through eleventh aspects is presented, wherein each of the plurality of recesses of the cladding inner surface is either (i) elliptical with a recess semi-minor axis coinciding with a radial line extending from the fiber longitudinal axis through the cladding inner surface or (ii) circular with a recess radius coinciding with a radial line extending from the fiber longitudinal axis through the inner surface.

According to a thirteenth aspect of the present disclosure, the anti-resonant hollow core optical fiber of any one of the ninth through twelfth aspects is presented, wherein (i) the cladding inner surface further comprises a plurality of inner portions at a first cladding inner radius from the fiber longitudinal axis that is substantially constant, and (ii) the plurality inner portions and the plurality of recesses alternate azimuthally around the fiber longitudinal axis.

According to a fourteenth aspect of the present disclosure, the anti-resonant hollow core optical fiber of any one of the ninth through thirteenth aspects further comprises an innermost series of anti-resonant elements, of which the at least one anti-resonant element is one, extending longitudinally from the first end to the second end, each of the innermost series of anti-resonant elements disposed between a different one of the plurality of recesses of the cladding inner surface and the fiber longitudinal axis.

According to a fifteenth aspect of the present disclosure, the anti-resonant hollow core optical fiber of the fourteenth aspect is presented, wherein each of the innermost series of anti-resonant elements has a convex surface facing the fiber longitudinal axis and a concave surface facing a different one of the plurality of recesses of the cladding inner surface.

According to a sixteenth aspect of the present disclosure, the anti-resonant hollow core optical fiber of any one of the fourteenth through fifteenth aspects is presented, wherein each of the innermost series of anti-resonant elements is either (i) elliptical with an arc semi-minor axis coinciding with a radial line extending from the fiber longitudinal axis through the anti-resonant element or (ii) circular with an arc outer radius coinciding with a radial line extending from the fiber longitudinal axis through the anti-resonant element.

According to a seventeenth aspect of the present disclosure, the anti-resonant hollow core optical fiber of the sixteenth aspect is presented, wherein the arc semi-minor axis or the arc outer radius, whichever is present, is within a range of from 10 μm to 50 μm.

According to an eighteenth aspect of the present disclosure, the anti-resonant hollow core optical fiber of any one of the fourteenth through seventeenth aspects further comprises an effective core region through which the fiber longitudinal axis extends, the effective core region comprising a core radius from the fiber longitudinal axis that is tangential to the innermost series of anti-resonant elements.

According to a nineteenth aspect of the present disclosure, the anti-resonant hollow core optical fiber of the eighteenth aspect is presented, wherein the core radius is within a range 5 μm to 100 μm.

According to a twentieth aspect of the present disclosure, the anti-resonant hollow core optical fiber of any one of the fourteenth through nineteenth aspects further comprises a first series of capillaries extending longitudinally from the first end to the second end, each of the first series of capillaries (i) disposed between a different one of the recesses of the cladding inner surface and a different one of the innermost series of anti-resonant elements and (ii) comprising a capillary axis that is parallel to the fiber longitudinal axis.

According to a twenty-first aspect of the present disclosure, the anti-resonant hollow core optical fiber of the twentieth aspect is presented, wherein (i) each of the first series of capillaries further comprises a capillary inner radius, a capillary outer radius, and a capillary thickness between the capillary inner radius and the capillary outer radius, (ii) the capillary outer radius is within a range of from 4 μm to 50 μm, and (iii) the capillary thickness is within a range of from 100 nm to 4000 nm.

According to a twenty-second aspect of the present disclosure, the anti-resonant hollow core optical fiber of any one of the twentieth through twenty-first aspects further comprises a second series of capillaries extending longitudinally from the first end to the second end, each of the second series of capillaries (i) disposed between a different one of the plurality of recesses of the cladding inner surface and a different one of the innermost series of anti-resonant elements, (ii) disposed neighboring a different one of the first series of capillaries but separated therefrom by a gap distance, and (iii) comprising a capillary axis that is parallel to the fiber longitudinal axis.

According to a twenty-third aspect of the present disclosure, the anti-resonant hollow core optical fiber of the twenty-second aspect is presented, wherein the gap distance is less than 10 times the capillary thickness.

According to a twenty-fourth aspect of the present disclosure, the anti-resonant hollow core optical fiber of any one of the fourteenth through twenty-third aspects further comprises a second series of anti-resonant elements extending longitudinally from the first end to the second end, each of the second series of anti-resonant elements disposed between a different one of the plurality of recesses of the cladding inner surface and a different one of the innermost series of anti-resonant elements.

According to a twenty-fifth aspect of the present disclosure, the anti-resonant hollow core optical fiber of the twenty-fourth aspect is presented, wherein each of the second series of anti-resonant elements is either (i) elliptical with an arc semi-minor axis coinciding with a radial line extending from the fiber longitudinal axis through the anti-resonant element or (ii) circular with an arc outer radius coinciding with a radial line extending from the fiber longitudinal axis through the anti-resonant element.

According to a twenty-sixth aspect of the present disclosure, the anti-resonant hollow core optical fiber of the twenty-fifth aspect is presented, wherein (i) each of the second series of anti-resonant elements is separated from a nearest one of the innermost series of anti-resonant elements by an offset distance measured along the radial line extending through both the anti-resonant element of the second series of anti-resonant elements and the anti-resonant element of the innermost series of anti-resonant elements, and (ii) the offset distance is within a range of from 1 μm to 20 μm.

According to a twenty-seventh aspect of the present disclosure, the anti-resonant hollow core optical fiber of any one of the twenty-fourth through twenty-sixth aspects further comprises a third series of anti-resonant elements extending longitudinally from the first end to the second end, each of the third series of anti-resonant elements disposed between a different one of the recesses of the cladding inner surface and a different one of the second series of anti-resonant elements.

According to a twenty-eighth aspect of the present disclosure, the anti-resonant hollow core optical fiber of the twenty-seventh aspect is presented, wherein each of the third series of anti-resonant elements is either (i) elliptical with an arc semi-minor axis coinciding with a radial line extending from the fiber longitudinal axis through the anti-resonant element or (ii) circular with an arc outer radius coinciding with a radial line extending from the fiber longitudinal axis through the anti-resonant element.

According to a twenty-ninth aspect of the present disclosure, the anti-resonant hollow core optical fiber of the twenty-eighth aspect is presented, wherein (i) each of the third series of anti-resonant elements is separated from a nearest one of the second series of anti-resonant elements by an outer offset distance measured along the radial line extending through both the anti-resonant element of the third series of anti-resonant elements and the anti-resonant element of the second series of anti-resonant elements, and (ii) the outer offset distance is within a range of from 8 μm to 30 μm.

According to a thirtieth aspect of the present disclosure, the anti-resonant hollow core optical fiber of any one of the first through twenty-ninth aspects is presented, wherein the cladding tube and the at least one anti-resonant element each comprise a composition comprising silica glass.

According to a thirty-first aspect of the present disclosure, the anti-resonant hollow core optical fiber of any one of the first through thirtieth aspects is presented, wherein the anti-resonant hollow core optical fiber exhibits a confinement loss of less than 0.10 dB/km for the fundamental mode of electromagnetic radiation having at each wavelength within a range of from 1300 nm to 1600 nm.

According to a thirty-second aspect of the present disclosure, the anti-resonant hollow core optical fiber of any one of the first through thirty-first aspects is presented, wherein the anti-resonant hollow core optical fiber exhibits a confinement loss of greater than 100 dB/km for higher order modes of electromagnetic radiation having at each wavelength within a range of from 1300 nm to 1600 nm.

According to a thirty-third aspect of the present disclosure, an anti-resonant hollow core optical fiber preform comprises: (A) a fiber longitudinal axis extending from a first end to a second end; (B) a cladding tube through which the fiber longitudinal axis extends, the cladding tube (1) extending longitudinally from the first end to the second end, (2) disposed azimuthally around the fiber longitudinal axis, and (3) comprising (a) a cladding outer surface at a cladding outer radius from the fiber longitudinal axis and (b) a cladding inner surface comprising at least one recess; and (C) at least one anti-resonant element in contact with the cladding inner surface, the at least one anti-resonant element extending longitudinally from the first end to the second end.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

In the Drawings:

FIG. 1 is a perspective view of an anti-resonant hollow core optical fiber of the present disclosure, illustrating a cladding tube extending from a first end to a second end along a fiber longitudinal axis and anti-resonant elements within the cladding tube;

FIG. 2 is a cross-sectional view of the anti-resonant hollow core optical fiber (without the anti-resonant elements to improve legibility), illustrating the cladding tube with a cladding inner surface forming a cladding interior and recesses into the cladding inner surface arranged azimuthally around the axis of rotation;

FIG. 3 is a cross-sectional view of embodiments of the anti-resonant hollow core optical fiber, illustrating the anti-resonant elements including an innermost series of anti-resonant elements disposed between recesses and the fiber longitudinal axis and defining an effective core region, a second series of anti-resonant elements disposed between the recesses and the innermost series of anti-resonant elements, and a first series of capillaries disposed between the recesses and the second series of anti-resonant elements;

FIG. 4 is a cross-sectional view of embodiments of the anti-resonant hollow core optical fiber, illustrating the anti-resonant elements including the innermost series of anti-resonant elements disposed between the recesses and the fiber longitudinal axis and defining the effective core region, the first series of capillaries disposed between the recesses and the innermost series of anti-resonant elements, and a second series of capillaries likewise disposed between the recesses and the innermost series of anti-resonant elements;

FIG. 5 is a cross-sectional view of embodiments of the anti-resonant hollow core optical fiber, illustrating the anti-resonant elements including the innermost series disposed between the recesses and the fiber longitudinal axis and defining the effective core region, the second series of anti-resonant elements disposed between the recesses and the innermost series of anti-resonant elements, and a third series of anti-resonant elements disposed between the recesses and the second series of anti-resonant elements;

FIG. 6A, pertaining to Example 1A, is a graph plotting confinement loss as a function of wavelength of electromagnetic radiation for a computer modeled anti-resonant hollow core optical fiber of the present disclosure, illustrating that the anti-resonant hollow core optical fiber exhibits a confinement loss that is less than 0.10 dB/km for the fundamental mode throughout an entirety of a wavelength range of from 1300 nm to 1600 nm;

FIG. 6B, pertaining to Example 1B, is a graph like that of FIG. 6A but where the computer modeled anti-resonant hollow core optical fiber included anti-resonant elements having a thickness greater than a thickness of the anti-resonant elements of Example 1A;

FIG. 6C, pertaining to Example 1C, is a graph like that of FIGS. 6A and 6B but where the computer modeled anti-resonant hollow core optical fiber included anti-resonant elements having a thickness greater than the thicknesses of the anti-resonant elements of Examples 1A and 1B;

FIG. 7A, pertaining to Example 2, shows a cross-section of a computer modeled anti-resonant hollow core optical fiber with the innermost series of anti-resonant elements and a first and second series of capillaries disposed between the recesses and the innermost series of anti-resonant elements;

FIG. 7B, pertaining to Example 2, is a graph plotting confinement loss as a function of wavelength of electromagnetic radiation for a computer modeled anti-resonant hollow core optical fiber of the present disclosure, illustrating that the anti-resonant hollow core optical fiber exhibits a confinement loss that is less than 0.50 dB/km for the fundamental mode throughout an entirety of a wavelength range of from 1300 nm to 1600 nm and a confinement loss that is about 1000 dB/km for higher order modes throughout the entirety of that wavelength range;

FIG. 7C, pertaining to Example 2, is a graph plotting confinement loss as a function of wavelength of electromagnetic radiation and as a function of overlap between anti-resonant elements, illustrating that the anti-resonant hollow core optical fiber exhibits a confinement loss for the fundamental mode that does not drastically increase as overlap increases;

FIG. 8A, pertaining to Example 3, shows a cross-section of a computer modeled anti-resonant hollow core optical fiber with the innermost series of anti-resonant elements, a second series of anti-resonant elements disposed between the recesses and the innermost series of anti-resonant elements, and a third series of anti-resonant elements disposed between the recesses and the second series of anti-resonant elements;

FIG. 8B, pertaining to Example 3, is a graph plotting confinement loss as a function of wavelength of electromagnetic radiation for a computer modeled anti-resonant hollow core optical fiber of the present disclosure, illustrating that the anti-resonant hollow core optical fiber exhibits a confinement loss for the fundamental mode that is less than about 0.10 dB/km throughout an entirety of a wavelength range of from 1300 nm to 1600 nm; and

FIG. 8C, pertaining to Example 3, is a graph plotting confinement loss as a function of wavelength of electromagnetic radiation and as a function of an outer offset distance between the second series of anti-resonant elements and the third series of anti-resonant elements for both the fundamental mode and higher order modes, illustrating that higher order extinction peaks at 1212 dB/km when the outer offset is 18.5 μm, showing that the anti-resonant hollow core optical fiber can exhibit high extinction of higher order modes while exhibiting low confinement loss for the fundamental mode.

### DETAILED DESCRIPTION

Reference will now be made in detail to the present preferred embodiments, examples of which are illustrated in the accompanying drawings. Whenever possible, the same reference numerals will be used throughout the drawings to refer to the same to the same or like parts.

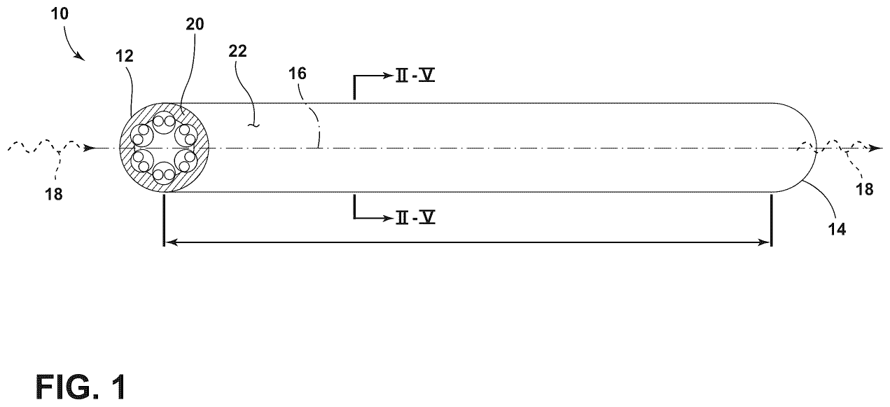

Referring to FIG. 1, an anti-resonant hollow core optical fiber 10 is herein disclosed. The anti-resonant hollow core optical fiber 10 includes a first end 12, a second end 14, and a fiber longitudinal axis 16. The fiber longitudinal axis 16 extends from the first end 12 to the second end 14. In use, electromagnetic radiation 18 is caused to enter the first end 12 and transmits through the anti-resonant hollow core optical fiber 10 out the second end 14.

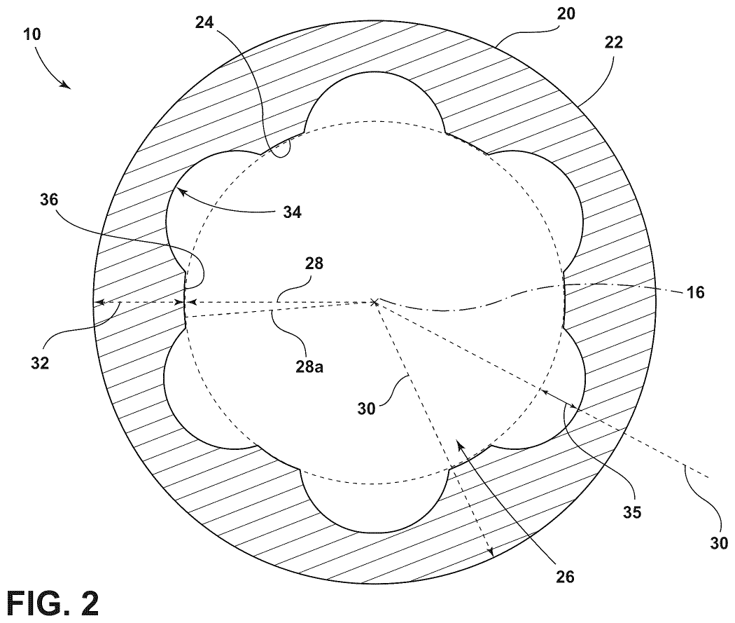

Referring now to FIGS. 2-5, the anti-resonant hollow core optical fiber 10 includes a cladding tube 20. The fiber longitudinal axis 16 extends through the cladding tube 20. The cladding tube 20 extends longitudinally from the first end 12 to the second end 14 of the anti-resonant hollow core optical fiber 10. The cladding tube 20 is disposed azimuthally around the fiber longitudinal axis 16. The cladding tube 20 includes a cladding outer surface 22 and a cladding inner surface 24. The cladding inner surface 24 defines a cladding interior 26. The cladding inner surface 24 is at a cladding inner radius 28 from the fiber longitudinal axis 16. The fiber longitudinal axis 16 extends through the cladding interior 26, which extends from the first end 12 to the second end 14. The cladding outer surface 22 is at a cladding outer radius 30 from the fiber longitudinal axis 16. The cladding tube 20 has a cladding thickness 32 between the cladding outer radius 30 and the cladding inner radius 28 measured orthogonally from the fiber longitudinal axis 16.

The cladding inner surface 24 includes at least one recess 34. The at least one recess 34 is further from the fiber longitudinal axis 16 than other portion(s) of the cladding inner surface 24. For example, the cladding inner radius 28 has azimuthal variability (e.g., is not entirely constant) around the fiber longitudinal axis 16, and that azimuthal variability defines the at least one recess 34.

In embodiments, the cladding inner surface 24 further comprises a plurality of recesses 34 into the cladding tube 20, one of which is the at least one recess 34. For example, the azimuthal variability of the cladding inner radius 28 can be periodic and thereby define the plurality of recesses 34. As another example, the cladding inner surface 24 can include a plurality of inner portions 36 that are at a first cladding inner radius 28a from fiber longitudinal axis 16, and the first cladding inner radius 28a is substantially constant (e.g., subject to manufacturing imprecision). The plurality of inner portions 36 and the plurality of recesses 34 alternate azimuthally around the fiber longitudinal axis 16 (e.g., one of the inner portions 36, one of the recesses 34, another one of the inner portions 36, another one of the recesses 34, and so on, azimuthally around the fiber longitudinal axis 16). In embodiments, the cladding inner surface 24 includes a total of from 3 to 12 recesses 34, such as 5 or 6 recesses 34. For example, the cladding inner surface 24 can include a total of 3, 4, 5, 6, 7, 8, 9, 10, 11, or 12 recesses 34.

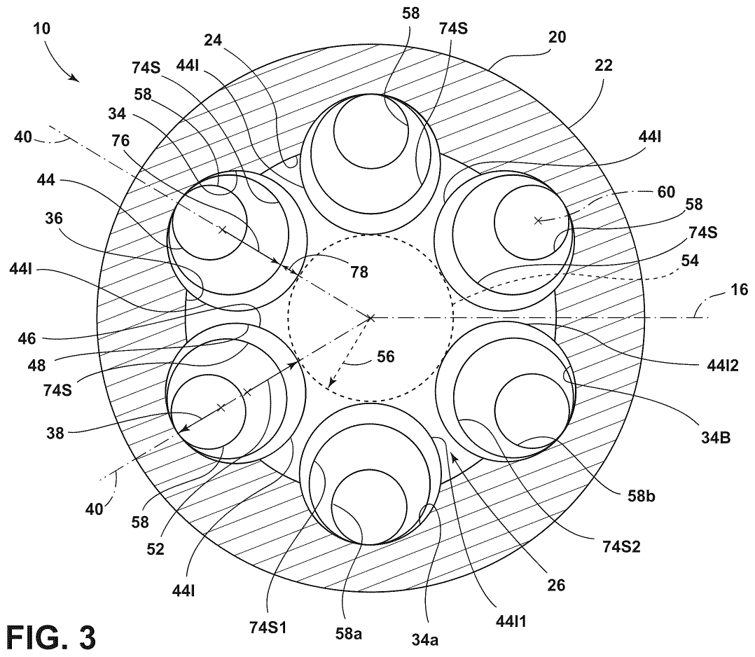

In embodiments, each of the plurality of recesses 34 is either elliptical or circular. When the recesses 34 are elliptical (see, e.g., FIG. 3), each recess can have a recess semi-minor axis 38 that coincides with a radial line 40 that extends from the fiber longitudinal axis 16 through the cladding inner surface 24. When the recesses 34 are circular (see, e.g., FIGS. 2, 4, and 5), each recess can have a recess radius 42 that coincides with the radial line 40. The plurality of recesses 34 can have other shapes besides elliptical or circular, as well (e.g., arcuate (a rounded shape other than elliptical or circular), groove, channel, slot).

The plurality of recesses 34 can have a recess depth 35 relative the first cladding inner radius 28a. The recess depth 35 is measured coincident with the radial line 40 extending through the deepest part of the recess 34.

In embodiments, the cladding thickness 32 has azimuthal variability (e.g., is not entirely constant) around the fiber longitudinal axis 16. For example, the cladding outer radius 30 can be constant azimuthally around the fiber longitudinal axis 16, while the cladding inner radius 28 is not constant, resulting in the cladding thickness 32 being azimuthally variable.

The anti-resonant hollow core optical fiber 10 further includes at least one anti-resonant element 44. The at least one anti-resonant element 44 is in contact with the cladding inner surface 24. For example, the at least one anti-resonant element 44 can be fused to the cladding inner surface 24. The at least one anti-resonant element 44 extends longitudinally from the first end 12 to the second end 14 of the anti-resonant hollow core optical fiber 10.

The at least one anti-resonant element 44 can take a variety of shapes and forms. For example, the at least one anti-resonant element 44 can be a capillary tube or otherwise provide a cylindrical portion. As another example, the at least one anti-resonant element 44 can be an arc. Examples of such capillary tubes and arcs will be discussed further below.

In embodiments, the at least one anti-resonant element 44 contacts (e.g., is fused to) the cladding inner surface 24 at the at least one recess 34. For example, the at least one anti-resonant element 44 can be at least partially situated within the at least one recess 34.

In embodiments, the at least one anti-resonant element 44 is one of an innermost series of anti-resonant elements 44I that define an effective core region 54 of the anti-resonant hollow core optical fiber 10. The innermost series of anti-resonant elements 44I extends longitudinally from the first end 12 to the second end 14. Each of the innermost series of anti-resonant elements 44I is disposed between a different one of the plurality of recesses 34 of the cladding inner surface 24 and the fiber longitudinal axis 16. For example, the anti-resonant element 44I1 is disposed between the recess 34a and the fiber longitudinal axis 16, the anti-resonant element 44I2 is disposed between the recess 34b and the fiber longitudinal axis 16, and so on.

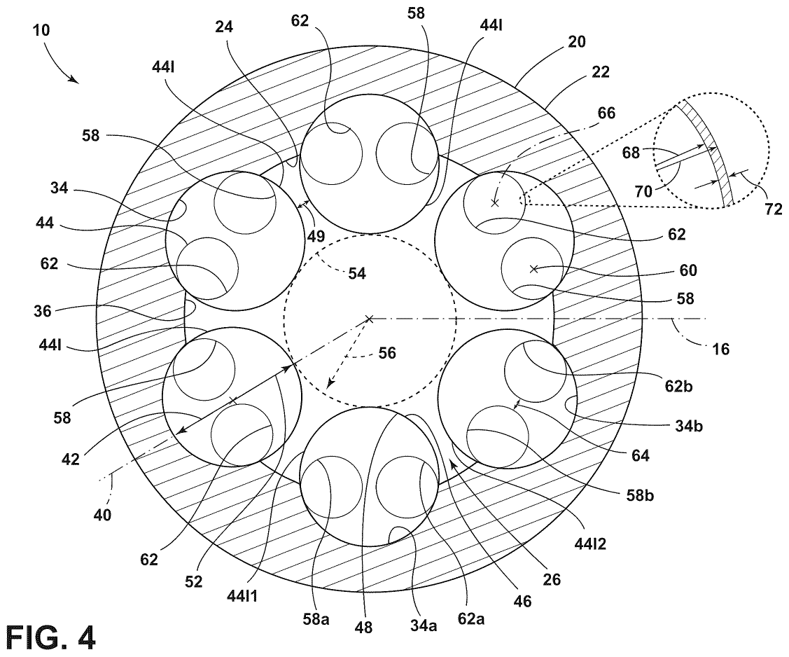

In embodiments, each of the innermost series of anti-resonant elements 44I has a convex surface 46 and a concave surface 48. The convex surface 46 faces the fiber longitudinal axis 16. The concave surface 48 faces a different one of the plurality of recesses 34. Adjacent anti-resonant elements 44I can be separated by a gap 49 (see FIG. 4). In embodiments, the gap 49 is within a range of from 1 μm to 5 μm. For example, the gap can be 1.0 μm, 1.5 μm, 2.0 μm, 2.5 μm, 3.0 μm, 3.5 μm, 4.0 μm, 4.5 μm, 5.0 μm, or within any range bound by any two of those values.

In embodiments, each of the innermost series of anti-resonant elements 44I is arcuate (not separately illustrated), elliptical (not separately illustrated), or circular (see, e.g., FIGS. 3-5). When each of the innermost series of anti-resonant elements 44I is elliptical, each of the innermost series of anti-resonant elements 44I includes an arc semi-minor axis (not separately illustrated) that coincides with a radial line 40 extending from the fiber longitudinal axis 16 through the anti-resonant element 44I. When each of the innermost series of anti-resonant elements 44I is circular, each of the innermost series of anti-resonant elements 44I includes an 4 coinciding with the radial line 40. In embodiments, the arc semi-minor axis or the arc outer radius 52, whichever is present, is within a range of from 10 μm to 50 μm. For example, the arc semi-minor axis or the arc outer radius 52, whichever is present, can be 10 μm, 15 μm, 20 μm, 25 μm, 30 μm, 35 μm, 40 μm, 45 μm, 50 μm, or within any range bound by any two of those values (e.g., from 20 μm to 40 μm, from 25 μm to 45 μm, and so on).

The anti-resonant hollow core optical fiber 10 further includes an effective core region 54. The fiber longitudinal axis 16 extends through the effective core region 54. The effective core region 54 includes a core radius 56 from the fiber longitudinal axis 16. The core radius 56 is tangential to the innermost series of anti-resonant elements 44I. In embodiments, the core radius 56 is within a range of from 5 μm to 100 μm. For example, the core radius 56 can be 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, or within any range bound by any two of those values (e.g., from 45 μm to 75 μm, from 50 μm to 95 μm, and so on).

In embodiments, the anti-resonant hollow core optical fiber 10 further includes a first series of capillaries 58. The first series of capillaries 58 extends longitudinally from the first end 12 to the second end 14. Each of the first series of capillaries 58 is disposed between a different one of the recesses 34 and a different one of the innermost series of anti-resonant elements 44I. For example, the capillary 58a is disposed between the recess 34a and the anti-resonant element 44I1, the capillary 58b is disposed between the recess 34a and the anti-resonant element 44I2, and so on. Each of the first series of capillaries 58 includes a first capillary axis 60 that is parallel to the fiber longitudinal axis 16.

In embodiments, the anti-resonant hollow core optical fiber 10 further includes a second series of capillaries 62. The second series of capillaries 62 likewise extends longitudinally from the first end 12 to the second end 14. Each of the second series of capillaries 62 is disposed between a different one of the recesses 34 and a different one of the innermost series of anti-resonant elements 44I. For example, the capillary 62a is disposed between the recess 34a and the anti-resonant element 44I1, the capillary 62b is disposed between the recess 34b and the anti-resonant element 44I2, and so on. Each of the second series of capillaries 62 can be disposed neighboring a different one of the first series of capillaries 58. In those instances, a gap distance 64 can separate the capillary of the first series of capillaries 58 and the capillary of the second series of capillaries 62 sharing the same recess 34. Each of the second series of capillaries 62 includes a second capillary axis 66 that is parallel to the fiber longitudinal axis 16 and the first capillary axis 60 of the first series of capillaries 58.

Each of the first series of capillaries 58 and each of the second series of capillaries 62 include a capillary inner radius 68 (see inset of FIG. 4) from the capillary axis 60, 66, (as the case may be), a capillary outer radius 70 from the capillary axis 60, 66 (as the case may be), and a capillary thickness 72. The capillary thickness 72 is measured between the capillary inner radius 68 and the capillary outer radius 70 orthogonally to the capillary axis 60, 66. In embodiments, the capillary outer radius 70 is within a range of from 4 μm to 50 μm. For example, the capillary outer radius 70 can be 4 μm, 10 μm, 15 μm, 20 μm, 25 μm, 30 μm, 35 μm, 40 μm, 45 μm, 50 μm, or within any range bound by any two of those values (e.g., from 10 μm to 35 μm, from 25 μm to 45 μm, and so on). In embodiments, the capillary thickness 72 is within a range of from 100 nm to 4000 nm. For example, the capillary thickness 72 can be 100 nm, 500 nm, 1000 nm, 1500 nm, 2000 nm, 2500 nm, 3000 nm, 3500 nm, 4000 nm, or within any range bound by any two of those values (e.g., from 1500 nm to 2500 nm, from 3000 nm to 4000 nm, and so on). In embodiments, the gap distance 64 is less than 10 times the capillary thickness 72, such as less than 5 times the capillary thickness 72. The gap distance 64 of such a value reduces tunneling loss between the two adjacent capillaries from the first series of capillaries 58 and the second series of capillaries 62.

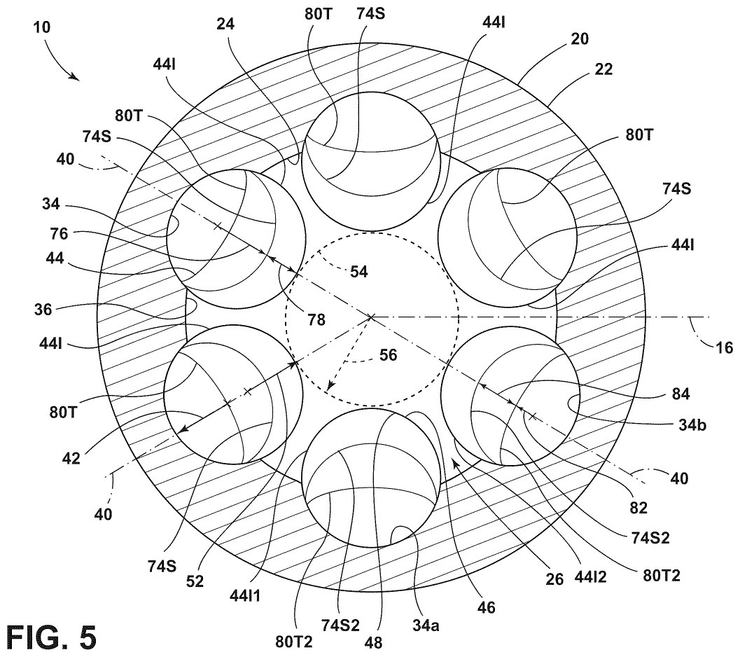

In embodiments, the anti-resonant hollow core optical fiber 10 further includes a second series of anti-resonant elements 74S (see FIGS. 3 and 5). The second series of anti-resonant elements 74S extends longitudinally from the first end 12 to the second end 14. Each of the second series of anti-resonant elements 74S is disposed between a different one of the plurality of recesses 34 of the cladding inner surface 24 and a different one of the innermost series of anti-resonant elements 44I. For example, anti-resonant element 74S1 is disposed between the recess 34a and the anti-resonant element 44I1, anti-resonant element 74S2 is disposed between the recess 34b and the anti-resonant element 44I2, and so on.

In embodiments, each of the second series of anti-resonant elements 74S is arcuate, elliptical, or circular (not separately illustrated). When each of the second series of anti-resonant elements 74S is elliptical, each of the second series of anti-resonant elements 74S includes an arc semi-minor axis 76 extending from the center of the ellipse to anti-resonant element 74S along a radial line 40 extending from the fiber longitudinal axis 16. When each of the second series of anti-resonant elements 74S is circular, each of the second series of anti-resonant elements 74S includes an arc outer radius (not separately illustrated) correspondingly coinciding with the radial line 40. In embodiments, the arc semi-minor axis 76 or the arc outer radius, whichever is present, is within a range of from 10 μm to 50 μm. For example, the arc semi-minor axis 76 or the arc outer radius, whichever is present, can be 10 μm, 15 μm, 20 μm, 25 μm, 30 μm, 35 μm, 40 μm, 45 μm, 50 μm, or within any range bound by any two of those values (e.g., from 20 μm to 40 μm, from 25 μm to 45 μm, and so on).

Each of the second series of anti-resonant elements 74S is separated from a nearest one of the innermost series of anti-resonant elements 44I by an offset distance 78 along the radial line 40. For example, the anti-resonant element 74S1 is most near the anti-resonant element 44I1, the anti-resonant element 74S2 is most near the anti-resonant element 44I2, and so on. The offset distance 78 is measured along the radial line 40 extending through the anti-resonant element of the second series of anti-resonant elements 74S, the anti-resonant element of the of the innermost series of anti-resonant elements 44I and the center of the ellipse or circle defined by anti-resonant element 74S. In embodiments, the offset distance 78 is within a range of from 1 μm to 20 μm. For example, the offset distance 78 can be 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, or within any range bound by any two of those values (e.g., from 8 μm to 18 μm, from 10 μm to 15 μm, and so on).

In embodiments, the anti-resonant hollow core optical fiber 10 further includes a third series of anti-resonant elements 80T (see, e.g., FIG. 5). The third series of anti-resonant elements 80T extends longitudinally from the first end 12 to the second end 14. Each of the third series of anti-resonant elements 80T is disposed between a different one of the plurality of recesses 34 of the cladding inner surface 24 and a different one of the second series of anti-resonant elements 74S. For example, anti-resonant element 80T1 is disposed between the recess 34a and the anti-resonant element 74S1, anti-resonant element 80T2 is disposed between the recess 34b and the anti-resonant element 74S2, and so on.

In embodiments, each of the third series of anti-resonant elements 80T is arcuate (not separately illustrated), elliptical (depicted in FIG. 5) or circular (not separately illustrated). When each of the third series of anti-resonant elements 80T is elliptical, each of the third series of anti-resonant elements 80T includes an arc semi-minor axis 82 that coincides with a radial line 40 extending from the fiber longitudinal axis 16 through the anti-resonant element 80T and the center of the ellipse defined by anti-resonant element 80T. When each of the third series of anti-resonant elements 80T is circular, each of the third series of anti-resonant elements 80T includes an arc outer radius (not separately illustrated) correspondingly coinciding with the radial line 40. In embodiments, the arc semi-minor axis 50 or the arc outer radius 52, whichever is present, is within a range of from 10 μm to 50 μm. For example, the arc semi-minor axis 50 or the arc outer radius 52, whichever is present, can be 10 μm, 15 μm, 20 μm, 25 μm, 30 μm, 35 μm, 40 μm, 45 μm, 50 μm, or within any range bound by any two of those values (e.g., from 20 μm to 40 μm, from 25 μm to 45 μm, and so on).

Each of the third series of anti-resonant elements 80T is separated from a nearest one of the second series of anti-resonant elements 74S by an outer offset distance 84 along the radial line 40. For example, the anti-resonant element 80T1 is most near the anti-resonant element 74S1, the anti-resonant element 80T2 is most near the anti-resonant element 74S2, and so on. The outer offset distance 84 is measured along the radial line 40 extending through the anti-resonant element of the third series of anti-resonant elements 80T, the anti-resonant element of the second series of anti-resonant elements 74S, and the center defining the ellipse or circle of anti-resonant element 80T. In embodiments, the outer offset distance 84 is within a range of from 8 μm to 30 μm. For example, the outer offset distance 84 can be 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, or within any range bound by any two of those values (e.g., from 11 μm to 16 μm, from 10 μm to 15 μm, and so on).

Each of the cladding tube 20 and the at least one anti-resonant element 44 (including the innermost series of anti-resonant elements 44I, first series of capillaries 58, the second series of capillaries 62, the second series of anti-resonant elements 74S, and the third series of anti-resonant elements 80T) have a composition that is or includes silica glass. The silica glass can be doped to adjust viscosity during manufacture as desired.

Each of the at least one anti-resonant element 44 (including the innermost series of anti-resonant elements 44I, the first series of capillaries 58, the second series of capillaries 62, the second series of anti-resonant elements 74S, and the third series of anti-resonant elements 80T) has a thickness 72. For example, as mentioned, the first series of capillaries 58 and the second series of capillaries 62 have the capillary thickness 72. The thickness 72 of any or all of the at least one anti-resonant element 44 described herein can be predetermined as a function of the intended operating wavelength of the anti-resonant hollow core optical fiber 10. For example, the thickness 72 can be within ±30%, ±25%, ±20%, ±15%, ±10%, or ±5% of a calculated thickness t as defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance (e.g., 1 for first order antiresonance), λ is the operating wavelength, and n is the refractive index of the material forming the anti-resonant element. In embodiments, the thickness 72 is within a range of from 100 nm to 4000 nm. For example, the thickness can be 100 nm, 500 nm, 1000 nm, 1500 nm, 2000 nm, 2500 nm, 3000 nm, 3500 nm, 4000 nm, or within any range bound by any two of those values (e.g., from 1500 nm to 2500 nm, from 3000 nm to 4000 nm, and so on).

In embodiments, the anti-resonant hollow core optical fiber 10 exhibits a confinement loss of less than 0.14 dB/km, or less than 0.12 dB/km, or less than 0.10 dB/km, or less than 0.08 dB/km, or less than 0.06 dB/km for the fundamental mode of electromagnetic radiation 18 (e.g., LP01) at each wavelength within a range of from 1300 nm to 1600 nm. That is below the confinement loss that optical fibers with a pure silica core exhibit. In embodiments, the anti-resonant hollow core optical fiber 10 exhibits a confinement loss of greater than 500 dB/km for higher order modes of electromagnetic radiation 18 at each wavelength within a range of from 1300 nm to 1600 nm.

In embodiments, the anti-resonant hollow core optical fiber 10 exhibits a confinement loss of less than 0.14 dB/km, or less than 0.12 dB/km, or less than 0.10 dB/km, or less than 0.08 dB/km, or less than 0.06 dB/km for the fundamental mode of electromagnetic radiation 18 at at least one wavelength within a range of from 1300 nm to 1600 nm.

In embodiments, the anti-resonant hollow core optical fiber 10 exhibits a confinement loss of less than 0.14 dB/km, or less than 0.12 dB/km, or less than 0.10 dB/km, or less than 0.08 dB/km, or less than 0.06 dB/km for the fundamental mode of electromagnetic radiation 18 at at least two wavelengths within a range of from 1300 nm to 1600 nm.

In embodiments, the anti-resonant hollow core optical fiber 10 exhibits a confinement loss of less than 0.14 dB/km, or less than 0.12 dB/km, or less than 0.10 dB/km, or less than 0.08 dB/km, or less than 0.06 dB/km for the fundamental mode of electromagnetic radiation 18 at a wavelength of 1310 nm, a wavelength of 1550 nm, or both a wavelength of 1310 nm and a wavelength of 1550 nm.

In embodiments, the anti-resonant hollow core optical fiber 10 exhibits a confinement loss of greater than 100 dB/km, or greater than 250 dB/km, or greater than 500 dB/km, or greater than 750 dB/km, or greater than 1000 dB/km for higher order modes of electromagnetic radiation 18 at each wavelength within a range of from 1300 nm to 1600 nm. By “higher order modes” it is meant all modes, collectively, other than the fundamental mode.

In embodiments, the anti-resonant hollow core optical fiber 10 exhibits a confinement loss of greater than 100 dB/km, or greater than 250 dB/km, or greater than 500 dB/km, or greater than 750 dB/km, or greater than 1000 dB/km for higher order modes of electromagnetic radiation 18 at at least one wavelength within a range of from 1300 nm to 1600 nm.

In embodiments, the anti-resonant hollow core optical fiber 10 exhibits a confinement loss of greater than 100 dB/km, or greater than 250 dB/km, or greater than 500 dB/km, or greater than 750 dB/km, or greater than 1000 dB/km for higher order modes of electromagnetic radiation 18 at at least two wavelengths within a range of from 1300 nm to 1600 nm.

In embodiments, the anti-resonant hollow core optical fiber 10 exhibits a confinement loss of greater than 100 dB/km, or greater than 250 dB/km, or greater than 500 dB/km, or greater than 750 dB/km, or greater than 1000 dB/km for higher order modes of electromagnetic radiation 18 at a wavelength of 1310 nm, a wavelength of 1550 nm, or both a wavelength of 1310 nm and a wavelength of 1550 nm.

In embodiments, the anti-resonant hollow core optical fiber 10 exhibits a confinement loss of less than 0.14 dB/km, or less than 0.12 dB/km, or less than 0.10 dB/km, or less than 0.08 dB/km, or less than 0.06 dB/km for the fundamental mode and a confinement loss of greater than 100 dB/km, or greater than 250 dB/km, or greater than 500 dB/km, or greater than 750 dB/km, or greater than 1000 dB/km for higher order modes of electromagnetic radiation 18 at each wavelength within a range of from 1300 nm to 1600 nm.

In embodiments, the anti-resonant hollow core optical fiber 10 exhibits a confinement loss of less than 0.14 dB/km, or less than 0.12 dB/km, or less than 0.10 dB/km, or less than 0.08 dB/km, or less than 0.06 dB/km for the fundamental mode and a confinement loss of greater than 100 dB/km, or greater than 250 dB/km, or greater than 500 dB/km, or greater than 750 dB/km, or greater than 1000 dB/km for higher order modes of electromagnetic radiation 18 at at least one wavelength within a range of from 1300 nm to 1600 nm.

In embodiments, the anti-resonant hollow core optical fiber 10 exhibits a confinement loss of less than 0.14 dB/km, or less than 0.12 dB/km, or less than 0.10 dB/km, or less than 0.08 dB/km, or less than 0.06 dB/km for the fundamental mode and a confinement loss of greater than 100 dB/km, or greater than 250 dB/km, or greater than 500 dB/km, or greater than 750 dB/km, or greater than 1000 dB/km for higher order modes of electromagnetic radiation 18 at at least two wavelengths within a range of from 1300 nm to 1600 nm.

In embodiments, the anti-resonant hollow core optical fiber 10 exhibits a confinement loss of less than 0.14 dB/km, or less than 0.12 dB/km, or less than 0.10 dB/km, or less than 0.08 dB/km, or less than 0.06 dB/km for the fundamental mode and a confinement loss of greater than 100 dB/km, or greater than 250 dB/km, or greater than 500 dB/km, or greater than 750 dB/km, or greater than 1000 dB/km for higher order modes of electromagnetic radiation 18 at a wavelength of 1310 nm, a wavelength of 1550 nm, or both a wavelength of 1310 nm and a wavelength of 1550 nm.

To manufacture the anti-resonant hollow core optical fiber 10, an anti-resonant hollow core optical fiber preform (hereinafter just “preform”) can first be made from separately formed tubes of differing radii representing the cladding tube and the anti-resonant elements. Tubes of small radius can be inserted into tubes of large radius to form tube assemblies that can be placed against recesses 34 of the cladding inner surface 24 of the cladding tube 20. Tube assemblies can include one or a plurality of tubes. Recesses 34 into the cladding inner surface 24 can be formed by machining grooves into the tube intended to be the cladding tube 20. A preform can be assembled by fusing the smaller silica tubes within the recesses 34 and into each other as necessary to form the desired geometry. Fusing can occur by heating to soften the tubes and cooling. The shape of anti-resonant elements (circular, elliptical, arcuate etc.) can be varied by applying and controlling pressure applied to the interiors of the tubes defining anti-resonant elements and/or the pressure differential between the tubes defining the anti-resonant elements and the effective core region. The optical fiber 10 can be drawn from the preform, with air pressures within the various silica tubes adjusted as necessary to produce the optical fiber 10 with the desired geometry.

It should be understood that the preform is a structural analog to the anti-resonant hollow core optical fiber 10, with the preform and the anti-resonant hollow core optical fiber 10 differing primarily in the dimensions of the components. The entirety of the discussion above concerning the anti-resonant hollow core optical fiber 10 applies equally as well to the preform (except for dimensions) without the need for duplicative drawings and discussion. For example, the preform includes a longitudinal axis 16 extending from a first end 12 to a second end 14. The preform includes a cladding tube 20 through which the longitudinal axis 16 extends. The cladding tube 20 extends longitudinally from the first end 12 to the second end 14. The cladding tube 20 is disposed azimuthally around the longitudinal axis 16. The cladding tube 20 includes a cladding outer surface 22 at a cladding outer radius 24 from the longitudinal axis 16. The cladding tube 20 includes a cladding inner surface 24 with at least one recess 34. The preform includes at least one anti-resonant element 44 in contact with the cladding inner surface 24. The at least one anti-resonant element 44 extends longitudinally from the first end 12 to the second end 14. And so on, without the need to repeat the entirety of the detailed description preceding this paragraph.

### EXAMPLES

Examples 1A-1C—For Examples 1A-1C, an anti-resonant hollow core optical fiber of the design illustrated in FIG. 4 was modeled using the Comsol Multiphysics® finite element software. The anti-resonant hollow core optical fiber design included a cladding inner surface with a plurality of inner portions at a first cladding radius from the fiber longitudinal axis that was constant and a plurality of recesses, with inner portions and the recesses alternating azimuthally around the fiber longitudinal axis. The anti-resonant hollow core optical fiber design further included an innermost series of anti-resonant elements with a convex surface facing the fiber longitudinal axis and a concave surface facing the recesses. The anti-resonant hollow core optical fiber design further included a first series of capillaries and a second series of capillaries in pairs disposed between the innermost series of anti-resonant elements and the plurality of recesses.

The parameters used for the modeling of all of Examples 1A-1C were as follows: (i) core radius=17.5 μm; (ii) capillary outer radius for both the first series of capillaries and the second series of capillaries=6.45 μm; (iii) arc outer radius for the innermost series of anti-resonant elements=15 μm, (iv) the gap distance between the two first series of capillaries and the second series of capillaries is 2.25 μm, (v) the gap between adjacent innermost anti-resonant elements=2.5 μm, and (vi) recess depth is 9 μm. The capillary thickness for both the first series of capillaries and the second series of capillaries and the thickness for the innermost series of anti-resonant elements were made equal and set to a different value for each of Examples 1A-1C, as follows: Example 1A=370 nm, Example 1B=450 nm, and Example 1C=550 nm.

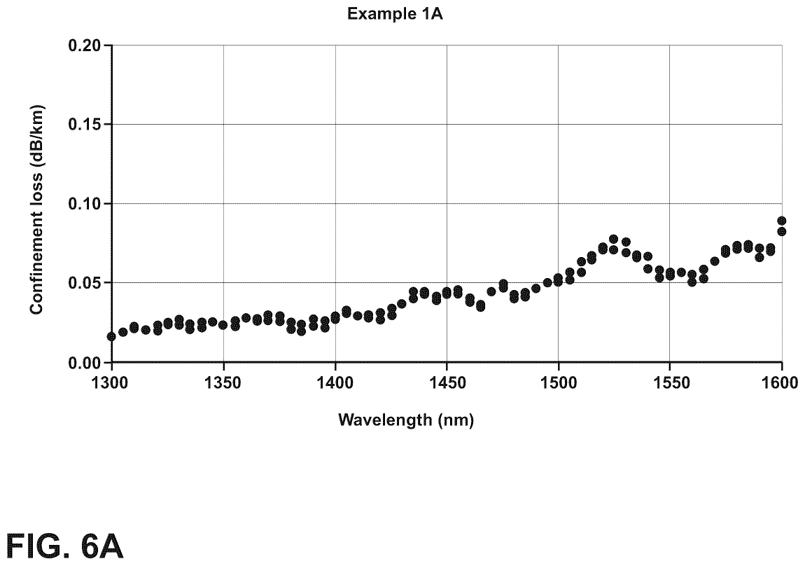

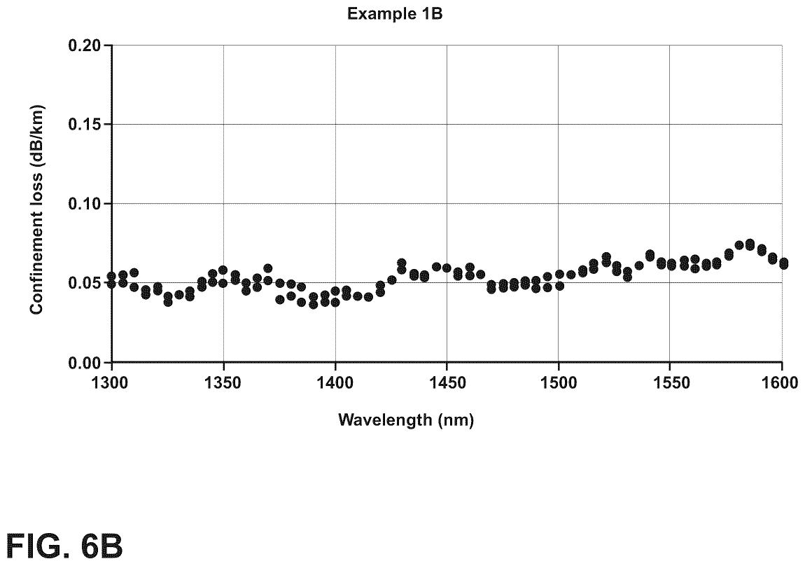

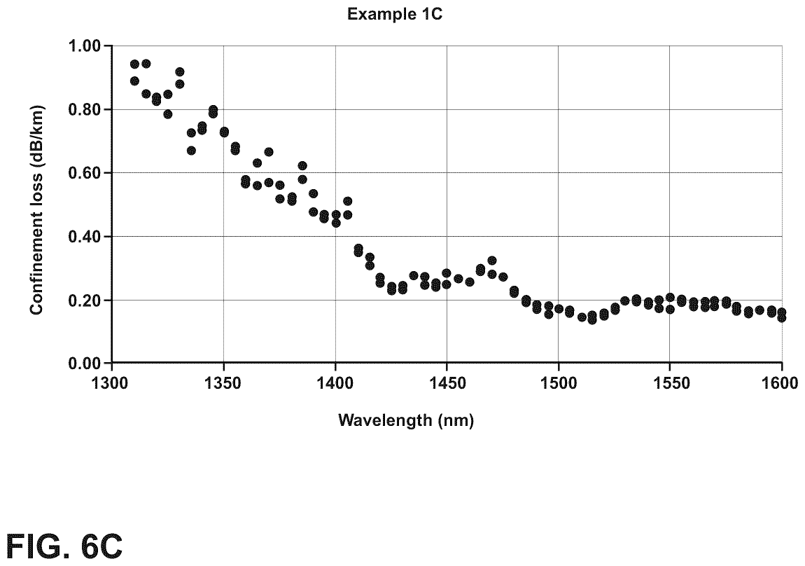

The modeling software was then used to calculate the confinement loss of the fundamental mode as a function of wavelength of electromagnetic radiation transmitted through the anti-resonant hollow core optical fiber of each of Examples 1A-1C. The results are reproduced in the graphs of FIGS. 6A-6C. As the graphs reveal, increasing the thickness of the anti-resonant elements shifts the wavelength range associated with low confinement loss toward longer wavelength ranges. Further, the graphs reveal that the anti-resonant hollow core optical fibers of the present disclosure can exhibit confinement losses of less than 0.10 dB/km or even less than 0.05 dB/km at desirable wavelength ranges that include 1310 nm and 1550 nm. More particularly, in reference to Example 1B (thickness=450 nm), confinement loss of less than 0.08 dB/km is exhibited throughout an entirety of the wavelength range of from 1300 nm to 1600 nm.

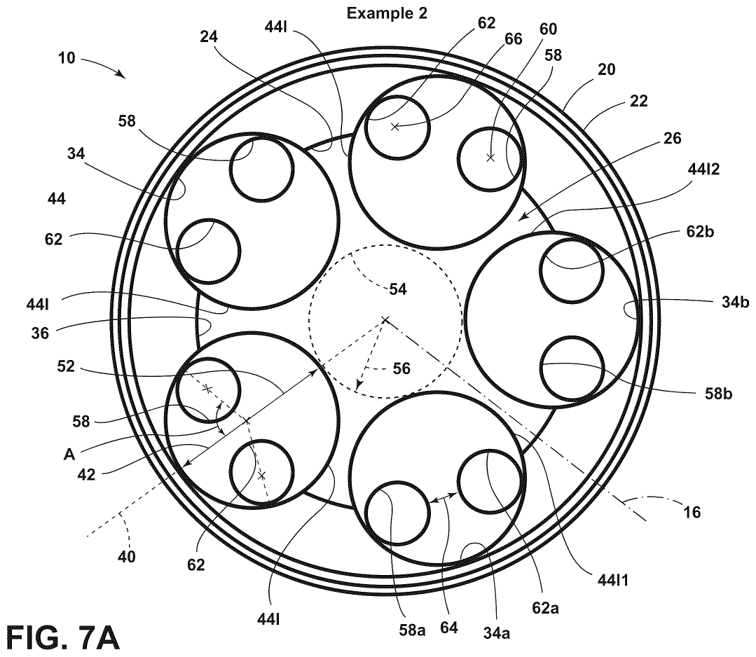

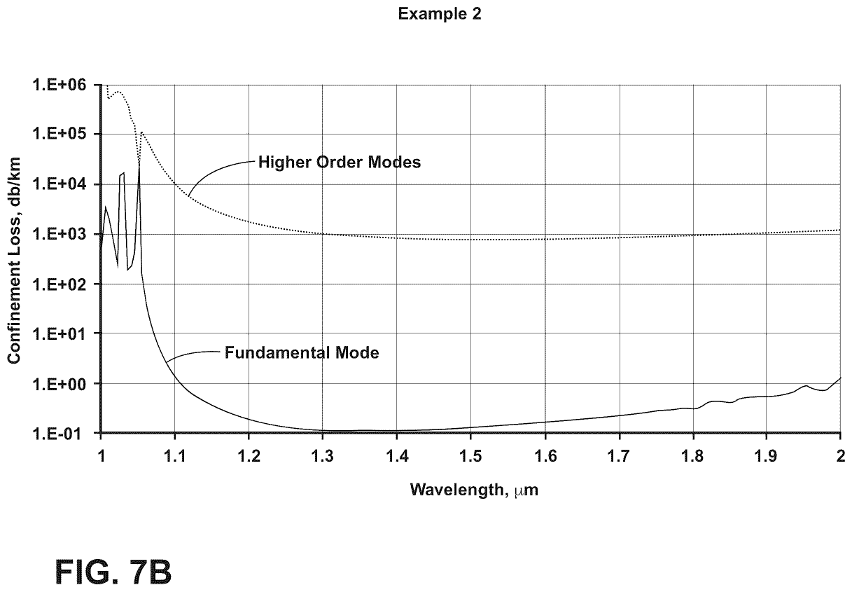

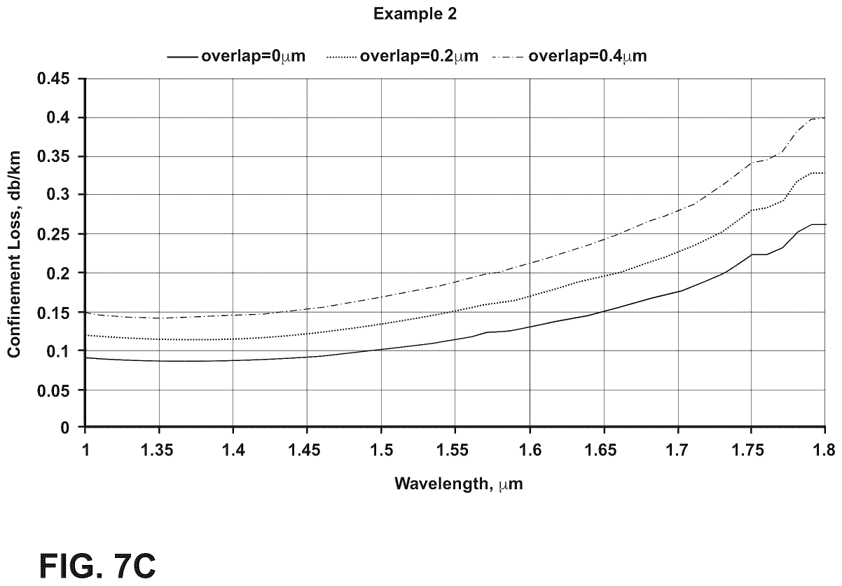

Example 2—For Example 2, an anti-resonant hollow core optical fiber of the design illustrated in FIG. 7A was modeled using the Comsol Multiphysics® finite element software. The design is similar to that of Examples 1A-1C except that five (not six) recesses, pairs of capillaries, and innermost anti-resonant elements are included. More particularly, the parameters used for the modeling of Example 2 were as follows: (i) core radius=17.5 μm; (ii) capillary outer radius for both the first series of capillaries and the second series of capillaries=7.5 μm; (iii) arc outer radius for the innermost series of anti-resonant elements=20 μm; (iv) capillary thickness for both the first series of capillaries and the second series of capillaries and thickness for the innermost series of anti-resonant elements=450 nm; (v) rotation A of first and second series of capillaries within the recesses relative to the radial line extending through the center of the recesses=70 degrees in opposite directions, (vi) no overlap of the first and second series of capillaries with the cladding tube, and (vii) sunken depth of structures into the cladding tube=15 μm.

The modeling software was then used to calculate the confinement loss as a function of wavelength of electromagnetic radiation transmitted through the anti-resonant hollow core optical fiber. The confinement loss was determined for both the fundamental mode and the higher order modes. The results are reproduced in the graph of FIG. 7B. It was hypothesized for Example 2 that a reduction in the number of recesses and anti-resonant elements would help achieve extinction of higher order modes (higher confinement loss) while only slightly increasing confinement loss of the fundamental mode. More particularly, while the design of Examples 1A-1C exhibits (according to modeling) a confinement loss of the fundamental mode of about 0.05 dB/km or lower over the wavelength range from 1300 nm to 1600 nm, it also exhibits a minimum loss for the higher order modes of only about 1 dB/km over the wavelength range from 1300 nm to 1600 nm, which is less preferred because extinction of the higher order modes during transmission can be desirable. In contrast, the design of Example 2 exhibits (according to modeling) a confinement loss of slightly above 0.1 dB/km for the fundamental mode over the wavelength range from 1300 nm to 1600 nm and a much greater confinement loss (about 1000 dB/km) for the higher order modes over the same wavelength range.

The modeling was then adjusted to replicate manufacturing imprecision. More particularly, the following parameter were added: overlap between the capillaries and the cladding tube=200 nm and 400 nm. The overlap between the capillaries and the cladding tube and the sunken depth of structures into the cladding tube were added to the modeling to examine the effects of imprecision or fluctuations in fiber geometry due to manufacturing limitations on confinement loss for the fundamental mode and higher order modes.

The modeling software was then used to calculate the confinement loss as a function of wavelength of electromagnetic radiation transmitted through the anti-resonant hollow core optical fiber. The confinement loss was determined for both the fundamental mode and the higher order modes. The confinement loss of the fundamental mode for overlaps of 0 nm, 200 nm, and 400 nm are reproduced in the graph of FIG. 7C. Increased overlap leads to a minor increase of confinement loss of the fundamental mode but does not produce any peaks or discontinuities in the confinement loss. The overlap here studied is known to degrade the performance of many anti-resonant hollow core optical fiber designs proposed in the art. The results of this example show that the hollow core fiber design disclosed herein is much less sensitive to overlap and thus is expected to be much more tolerant of variability in manufacturing conditions than other designs.

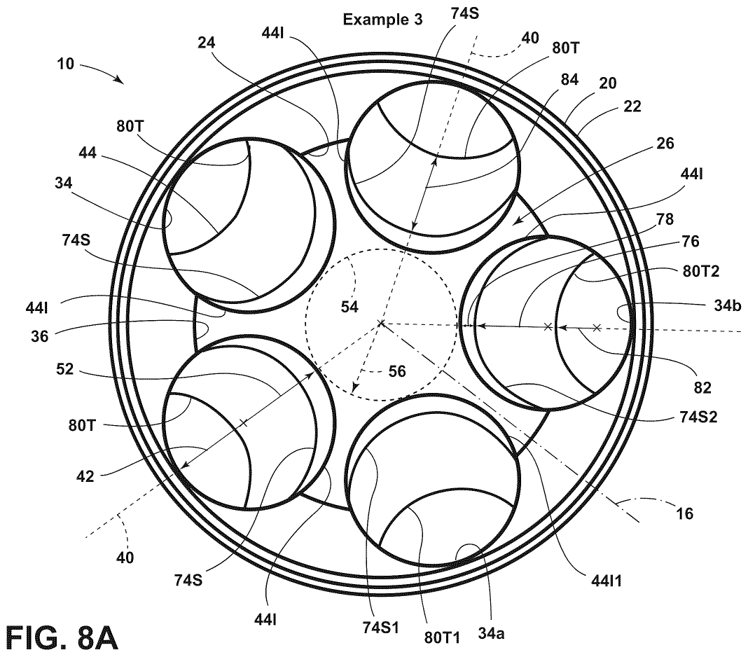

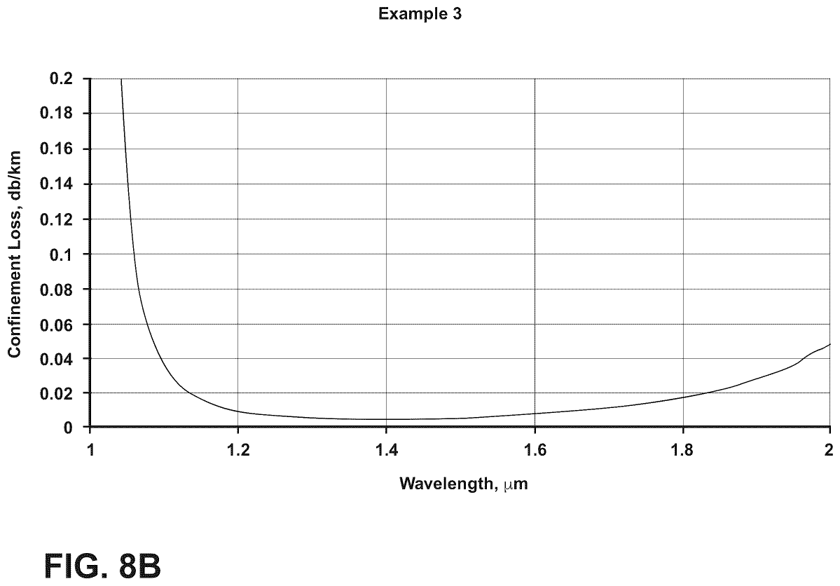

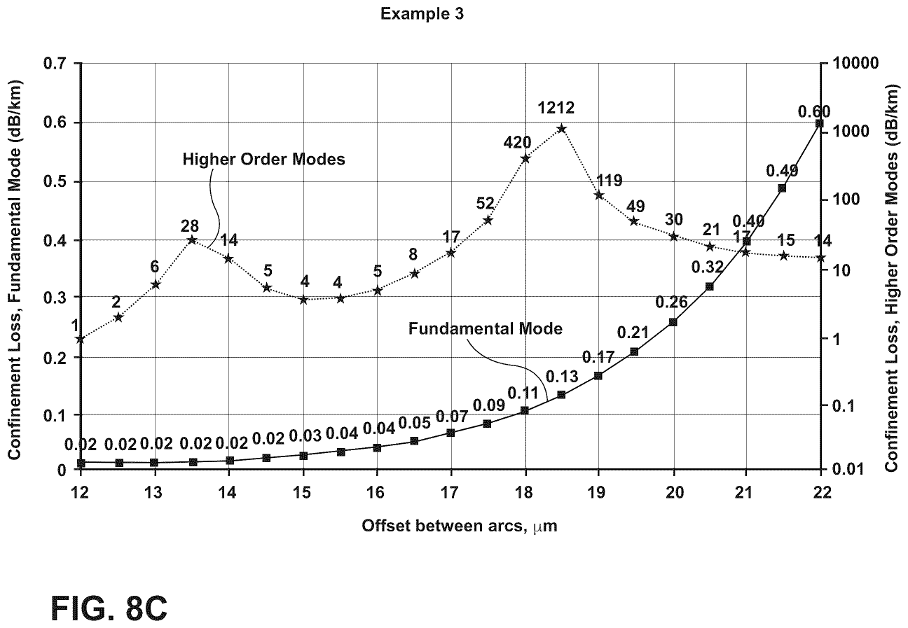

Example 3—For Example 3, an anti-resonant hollow core optical fiber of the design illustrated in FIG. 8A was modeled using the Comsol Multiphysics® finite element software. The anti-resonant hollow core optical fiber design included a cladding inner surface with a plurality of inner portions at a first cladding radius from the fiber longitudinal axis that was constant and a plurality of recesses, with inner portions and the recesses alternating azimuthally around the fiber longitudinal axis. The anti-resonant hollow core optical fiber design further included an innermost series of anti-resonant elements with a convex surface facing the fiber longitudinal axis and a concave surface facing the recesses. The anti-resonant hollow core optical fiber design further included a second series of anti-resonant elements between the recess and the innermost series of anti-resonant elements and a third series of anti-resonant elements between the recess and the second series of anti-resonant elements. More particularly, the parameters used for the modeling of Example 3 were as follows: (i) core radius=17.5 μm; (ii) arc outer radius for the innermost, second, and third series of anti-resonant elements=20 μm; (iii) thickness of the innermost, second, and third series of anti-resonant elements=450 nm; (iv) offset distance between the second series of anti-resonant elements and the innermost series of anti-resonant elements=4 μm; (v) outer offset distance between the third series of anti-resonant elements and the second series of anti-resonant elements=18 μm; and (vi) sunken depth of structures into the cladding tube=15 μm.

The modeling software was then used to calculate the confinement loss as a function of wavelength of electromagnetic radiation transmitted through the anti-resonant hollow core optical fiber. The confinement loss was determined for both the fundamental mode and the higher order modes. The results for the fundamental mode are reproduced in the graph of FIG. 8B. The graph reveals that there are no peaks or discontinuities in the confinement loss of the fundamental mode between 1200 nm and 2000 nm, despite the manufacturing imprecision built into the modeling via the sunken depth. This is a key feature of this design family, which is achieved by attaching the anti-resonant elements to the cladding tubes and avoiding any hanging nodes.

The model was then adjusted to make the outer offset distance between the third series of anti-resonant elements and the second series of anti-resonant elements variable. Confinement loss for the fundamental mode and higher order modes as a function of wavelength and the outer offset distance was calculated. The results are set forth in the graph reproduced at FIG. 8C. The graph shows that an optimal outer offset distance can be within a range of from 18 μm and 19 μm, where the confinement loss of the fundament mode is within a range of from 0.11 dB/km and 0.17 dB/km (e.g., relatively low) but the configuration of the higher modes reaches as high as 1212 dB/km (e.g., desirable high extinction of the higher modes).

It will be apparent to those skilled in the art that various modifications and variations can be made without departing from the spirit or scope of the claims.

What is claimed is:

1. An anti-resonant hollow core optical fiber comprising:
a fiber longitudinal axis extending from a first end to a second end;
a cladding tube through which the fiber longitudinal axis extends, the cladding tube (1) extending longitudinally from the first end to the second end, (2) disposed azimuthally around the fiber longitudinal axis, and (3) comprising (a) a cladding outer surface at a cladding outer radius from the fiber longitudinal axis and (b) a cladding inner surface comprising at least one recess; and
at least one anti-resonant element in contact with the cladding inner surface, the at least one anti-resonant element extending longitudinally from the first end to the second end.

2. The anti-resonant hollow core optical fiber of claim 1, wherein the cladding inner surface is disposed at a cladding inner radius that has azimuthal variability around the fiber longitudinal axis to define the at least one recess.

3. The anti-resonant hollow core optical fiber of claim 2, wherein the azimuthal variability of the cladding inner radius is periodic to define a plurality of recesses, the plurality comprising the at least one recess.

4. The anti-resonant hollow core optical fiber of claim 2, wherein the cladding tube further comprises a cladding thickness between the cladding outer radius and the cladding inner radius, and the cladding thickness has azimuthal variability around the fiber longitudinal axis.

5. The anti-resonant hollow core optical fiber of claim 1, wherein the at least one anti-resonant element is a capillary tube.

6. The anti-resonant hollow core optical fiber of claim 1, wherein the at least one anti-resonant element has an arcuate, elliptical, or circular cross-sectional segment.

7. The anti-resonant hollow core optical fiber of claim 1, wherein the at least one anti-resonant element contacts the cladding inner surface at the at least one recess.

8. The anti-resonant hollow core optical fiber of claim 1, wherein the cladding inner surface further comprises a plurality of recesses into the cladding tube, the plurality comprising the at least one recess.

9. The anti-resonant hollow core optical fiber of claim 8, wherein each of the plurality of recesses of the cladding inner surface is either (i) elliptical with a recess semi-minor axis coinciding with a radial line extending from the fiber longitudinal axis through the cladding inner surface or (ii) circular with a recess radius coinciding with a radial line extending from the fiber longitudinal axis through the inner surface.

10. The anti-resonant hollow core optical fiber of claim 8, wherein the cladding inner surface further comprises a plurality of inner portions at a first cladding inner radius from the fiber longitudinal axis that is substantially constant, and the plurality of inner portions and the plurality of recesses alternate azimuthally around the fiber longitudinal axis.

11. The anti-resonant hollow core optical fiber of claim 8 further comprising:
an innermost series of anti-resonant elements, of which the at least one anti-resonant element is one, extending longitudinally from the first end to the second end, each of the innermost series of anti-resonant elements disposed between a different one of the plurality of recesses of the cladding inner surface and the fiber longitudinal axis.

12. The anti-resonant hollow core optical fiber of claim 11, wherein each of the innermost series of anti-resonant elements has a convex surface facing the fiber longitudinal axis and a concave surface facing a different one of the plurality of recesses of the cladding inner surface.

13. The anti-resonant hollow core optical fiber of claim 11, wherein each of the innermost series of anti-resonant elements is either (i) elliptical with an arc semi-minor axis coinciding with a radial line extending from the fiber longitudinal axis through the anti-resonant element or (ii) circular with an arc outer radius coinciding with a radial line extending from the fiber longitudinal axis through the anti-resonant element.

14. The anti-resonant hollow core optical fiber of claim 11 further comprising:
a first series of capillaries extending longitudinally from the first end to the second end, each of the first series of capillaries (i) disposed between a different one of the recesses of the cladding inner surface and a different one of the innermost series of anti-resonant elements and (ii) comprising a capillary axis that is parallel to the fiber longitudinal axis.

15. The anti-resonant hollow core optical fiber of claim 14 further comprising:
a second series of capillaries extending longitudinally from the first end to the second end, each of the second series of capillaries (i) disposed between a different one of the plurality of recesses of the cladding inner surface and a different one of the innermost series of anti-resonant elements, (ii) disposed neighboring a different one of the first series of capillaries but separated therefrom by a gap distance, and (ii) comprising a capillary axis that is parallel to the fiber longitudinal axis.

16. The anti-resonant hollow core optical fiber of claim 11 further comprising:
a second series of anti-resonant elements extending longitudinally from the first end to the second end, each of the second series of anti-resonant elements disposed between a different one of the plurality of recesses of the cladding inner surface and a different one of the innermost series of anti-resonant elements.

17. The anti-resonant hollow core optical fiber of claim 16 further comprising:
a third series of anti-resonant elements extending longitudinally from the first end to the second end, each of the third series of anti-resonant elements disposed between a different one of the recesses of the cladding inner surface and a different one of the second series of anti-resonant elements.

18. The anti-resonant hollow core optical fiber of claim 1, wherein the anti-resonant hollow core optical fiber exhibits a confinement loss of less than 0.10 dB/km for the fundamental mode of electromagnetic radiation having at each wavelength within a range of from 1300 nm to 1600 nm.

19. The anti-resonant hollow core optical fiber of claim 1, wherein the anti-resonant hollow core optical fiber exhibits a confinement loss of greater than 100 dB/km for higher order modes of electromagnetic radiation having at each wavelength within a range of from 1300 nm to 1600 nm.

20. An anti-resonant hollow core optical fiber preform comprising:
a fiber longitudinal axis extending from a first end to a second end;
a cladding tube through which the fiber longitudinal axis extends, the cladding tube (1) extending longitudinally from the first end to the second end, (2) disposed azimuthally around the fiber longitudinal axis, and (3) comprising (a) a cladding outer surface at a cladding outer radius from the fiber longitudinal axis and (b) a cladding inner surface comprising at least one recess; and
at least one anti-resonant element in contact with the cladding inner surface, the at least one anti-resonant element extending longitudinally from the first end to the second end.
